(19) United States
(12) Patent Application Publication
(10) Pub. No.: US 2014/0289623 A1
(43) Pub. Date: Sep. 25, 2014

(54) Methods and Systems for Using Proxies to Noninvasively Alter Media Experiences

(71) Applicants: Brian Riggs, Berkeley, CA (US); Edwin Van Rijkom, Utrecht (NL)

(72) Inventors: Brian Riggs, Berkeley, CA (US); Edwin Van Rijkom, Utrecht (NL)

(73) Assignee: Adobe Systems Incorporated, San Jose, CA (US)

(21) Appl. No.: 12/613,623

(22) Filed: Nov. 6, 2009

(51) Int. Cl. G06F 3/00

(52) U.S. Cl. 715/716

(57) ABSTRACT

Embodiments include a computing system configured by a media player to access code defining a media presentation, identify a media element comprised in the media presentation, and determine a trait exposed by the media element. The code defining the media presentation may comprise a playlist declaring a plurality of elements or the code for the media player may include declaration of the media elements as instances of classes that each correspond to types of media elements. The computing system can be configured to generate media player behaviors based on the trait exposed by the media element. For example, media player logic can be invoked based on the exposed traits to pass events and commands to program components (e.g., class instances) corresponding to the media elements.

### TECHNICAL FIELD

The disclosure below generally relates to software development, particularly to media players.

### BACKGROUND

A media player can comprise an application that is used to provide audio, video, and other playback and can include additional functionality. A media player can support an application programming interface (API) for controls to provide commands such as play, pause, seek, and other commands directing operation of the media player as it uses its behavioral logic to play content such as video and audio. An API may also allow for use of other media player features as well.

In practice, the media player may be part of a complex system involving numerous parties. For example, a content provider may code a media player for use by clients to view content such as movies or television shows, with revenue generated based on advertisements presented during breaks in the content and/or using other media (e.g., banner ads) alongside the content. The content may be provided by the content provider, but the advertisements may be provided by a partner of the content provider. Other partners may be involved in tracking user activity (e.g., ad views) and providing additional functionality (e.g., avenues for purchase of the media through an ecommerce site, sharing the media through social networks, etc.).

One approach is to customize each instance of the media player. This can be time-consuming and expensive, since a developer must work with not only the media player APIs, but also APIs for code associated with the various partners. For instance, the media player may utilize plug-ins for various providers, but the plug-ins typically do not share an API and, unless the media player API is customized to interact with the plug-ins, the plug-ins may have little or no control over other media player functions.

### SUMMARY

Embodiments of the present subject matter include a media player with support for a trait-based API to dynamically configure operation of the media player based on traits exposed by media elements. Support for proxy elements can advantageously allow media player developers to noninvasively alter the media experience. Particularly, developers can use proxy elements to adjust functionality of a media player without needing to change the API supported by the media player while also allowing for fine-grained control of the media playback by using the proxy elements to change how the media player handles traits.

Embodiments include a computing system configured by a media player to access code defining a media presentation, identify a media element comprised in the media presentation, and determine a trait exposed by the media element. The code defining the media presentation may comprise a playlist declaring a plurality of elements or the code for the media player may include declaration of the media elements as instances of classes that each correspond to types of media elements. The computing system can be configured to generate media player behaviors based on the trait(s) exposed by the media element. For example, media player logic can be invoked based on the exposed traits to pass events and commands to program components (e.g., class instances) corresponding to the media elements.

The computing system can determine if a media element comprises a proxy media element wrapping a wrapped media element and, if so, to determine the trait(s) exposed by the media element based on a parameter included in code defining the proxy media element. For example, determining a trait may comprise determining a trait exposed by the wrapped media element and treating the trait exposed by the wrapped media element as being exposed by the proxy media element. As another example, determining a trait can comprise identifying a trait exposed by the wrapped media element and making a change to the trait based on the parameter included in code defining the proxy media element, the trait as changed comprising the trait of the proxy media element. As a further example, determining a trait can comprise identifying a trait based on a parameter included in code defining the proxy media element, the identified trait being different from a trait, if any, exposed by the wrapped media element.

In addition to or instead of invoking an operation supported by code of the media player in response to exposed traits, the computing system may generate media player behavior by invoking an operation supported by code of a plugin, the plugin associated with the proxy media element.

Embodiments also include methods and computer-readable media implementing one or more aspects of the present subject matter. These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a block diagram showing an exemplary computing system configured to provide a media player.

FIG. 2 is a block diagram showing an exemplary architecture for a media player that supports proxy media elements.

FIG. 3 is a flowchart showing steps in an exemplary method of providing trait-based media player behavior.

FIG. 4 is a diagram illustrating operation of a media player that supports proxy media elements.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

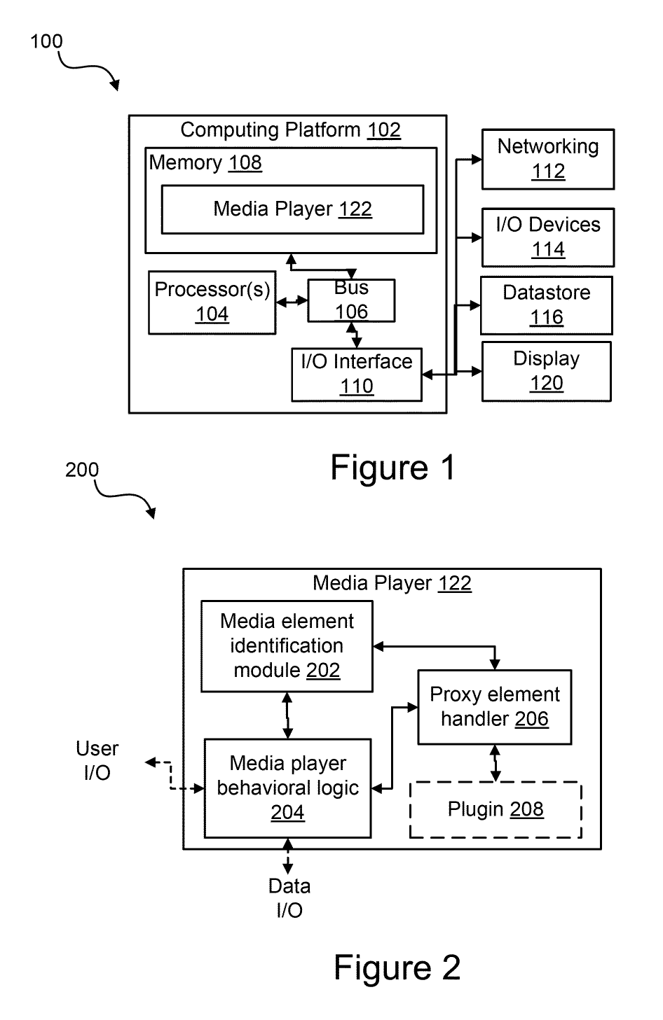

FIG. 1 is a block diagram showing an exemplary computing system 100 configured to provide a media player that supports trait-based media presentations. In this example, computing system 100 comprises a computing platform 102, which may comprise a desktop, laptop, server, or other computer or another computing device (e.g., PDA, mobile phone, set-top box, video gaming device, DVD/DVR, television, or other device). Computing platform 102 includes one or more processors 104 with access via bus 106 to a tangible computer-readable medium 108 which can comprise RAM, ROM, cache, or Flash memory or any other suitable storage medium. Additional components include input-output (I/O) interface components 110, which can comprise one or more busses, graphics processors, etc. for facilitating connection with various devices included in or interfaced to platform 102.

Computing platform 102 also includes one or more networking or other interfaces 112 (e.g., Ethernet, USB, etc.), user input (UI) devices 114 (e.g., a mouse, keyboard, touch screen interface, remote control, etc.), a data store 116, which can represent nonvolatile storage devices (e.g., hard disk, optical drive(s)), and a display device 120. Memory 108 embodies various program components, including a media player 122. Other program components, such as an operating system, other applications, and the like may also be resident in memory. The media player may comprise a stand-alone application, a plug-in for another application, or may be representative of functionality of an application (e.g., a web browser) with built-in media playback functionality.

FIG. 2 is a block diagram showing an exemplary architecture 200 for a media player such as media player 122 of FIG. 1. In accordance with the present subject matter, a media player can be configured to operate based on traits of media elements comprising a media presentation. The media elements may be defined based on a playlist accessed as a separate document/file by the media player or may be defined by code compiled into the media player itself. As noted below, in some embodiments, the media player is configured to recognize proxy elements and handle them accordingly.

Generally, a trait-based media player can comprise a playback component configured to utilize at least one selectively-enabled functional component of the media player to generate output based on evaluating the trait(s) exposed by the selected element. For instance, the media player can support an API for different operations that provide media player behavior, with different operations selected based on the exposed traits of one or more media elements. In some embodiments, code for a media player can include data defining a media composition by declarations of media elements in parallel and/or in series.

Exposed traits can be determined by analyzing the type of media included in the selected element or the particular element declared (e.g., a video element, an audio element, etc.). For example, some elements may expose a “visible” trait and a “temporal” trait and, in response, the media player can selectively enable or disable aspects of a video playback component for output of those elements while disabling aspects of the video playback component when those traits are not present. As another example, other elements may be “visible” but may not expose the “temporal” trait, and so the media player can enable suitable components for rendering non-video content; other elements (e.g., audio) may be “temporal” but not “visible.”

Exemplary discussion of trait-based media players can be found in U.S. patent application Ser. Nos. 12/548,782, and 12/548,728, both filed Aug. 27, 2009, and both of which are incorporated by reference herein in their respective entireties.

The example architecture of FIG. 2 includes a media element identification module 202 and media player behavioral logic 204. For example, media element identification module 202 may comprise code/processes operative to identify a plurality of media elements of a media composition as specified in external code or as specified in code for the media player. As an example, identification module 202 may access data specifying a composition in terms of a parent element with nested children elements, with the elements declared in accordance with an API for the media player.

Media player behavioral logic 204 represents code/processes operative to provide media player behavior including, but not limited to, user input/output and data input/output. For example, behavioral logic 204 can include methods and operations for playing back video and audio using various codecs, providing user interface elements, loading media content and plugins, and otherwise for providing the media player functions. Based on the trait(s) exposed by the elements of a media composition, different media player operations can be invoked.

For example, identification module 202 may include code for aggregating traits based on a plurality of elements of a composition, such as traits of a video and audio element to be presented in parallel. The exposed traits for the composition can comprise “visible,” “audible,” and “temporal,” thus invoking media player functionality for providing audiovisual output over time (e.g., video playback). During another portion of the composition, an image element may be presented, which may only be “visible,” but not “audible” or “temporal.” Accordingly, different media player functionality (e.g., raster/vector graphics output) can be invoked.

This example illustrates a proxy element handler 206 that can be used in embodiments that support proxy media elements. For example, proxy element handler 206 may comprise a separate module or may be included in the media element identification module as part of an overall “media element factory” that generates components for the media elements (e.g., instances of a one or more classes each corresponding to a type of media element) based on declarations in code. The class instances or other components can support various operations corresponding to their traits. For example, a video element may ordinarily expose traits such as “visible,” “loadable,” and “temporal,” which causes the media player to provide commands to load the video, display the video, and to present controls that relay playback commands to the video.

Proxy element handler 206 can configure the media player to determine if a media element is declared a proxy media element wrapping one or more other media elements supported by the player (the other elements referred to as “wrapped media element(s)”) and, if so, to determine the trait exposed by the media element based on a parameter included in code defining the proxy media element. For example, in some embodiments, a proxy element changes the trait(s) exposed by the wrapped media element by adding one or more additional traits that would not ordinarily be exposed and/or by removing or adjusting a trait that would ordinarily be exposed. The proxy element may or may not expose one or more traits that would ordinarily be exposed by the wrapped element.

For example, a temporal proxy element may be used to add a duration (or other temporal parameter) to a static media element such as an image so that the wrapped image element can be considered “temporal” in the same manner as a video or audio component. The original trait exposed by the image (e.g., “visible,” “spatial”) can be exposed by the temporal proxy element.

Additionally or alternatively, the proxy element handler can maintain a list of plugins 208 compiled into media player 122, loaded by media player 122, or otherwise accessible to the media player and can use the list of plugins to determine when to invoke plugin code based on traits exposed by a proxy media element (or elements) associated with the plugin.

As a particular example, assume that a content provider uses a content delivery partner to actually distribute data to clients and the content delivery partner requires a token in a URL identifying media, such as data of a video element. Ordinarily, the video element may expose a “loadable” trait that indicates to the player that the element comprises loadable content that will indicate to the player whether or not it is available. However, if the player simply tries to load the video content using the URL only (e.g., by invoking the load( )command), it will never arrive; the player would need to include code for obtaining the token and providing it along with the URL.

In accordance with the present subject matter, the content delivery partner (or another entity) can code a plugin to be associated with a proxy element to wrap video elements. The proxy element can expose the “loadable” trait to the player, but can also intercept commands from the player to load the URL and utilize logic for performing the token retrieval and authentication tasks. Then, the proxy can indicate to the media player whether load is successful.

As another example, an advertising integration partner can write a plugin to automatically retrieve advertising content. For instance, a proxy element can wrap video (or other) media elements and present the traits otherwise associated with the elements (e.g., “loadable,” “playable,” “visible,” etc.). However, when the player invokes a command via the API, such as “play( )”, the proxy obtains ad content and inserts the content before and after the video.

As a further example, a tracking partner can provide a plugin comprising code to collect data representing events or commands sent to and from elements wrapped in a tracking proxy. The tracking proxy would appear to the video player in the same way as the wrapped elements would, but can also collect events such as play( ) pause( ) or other commands and then send the data to a tracking server.

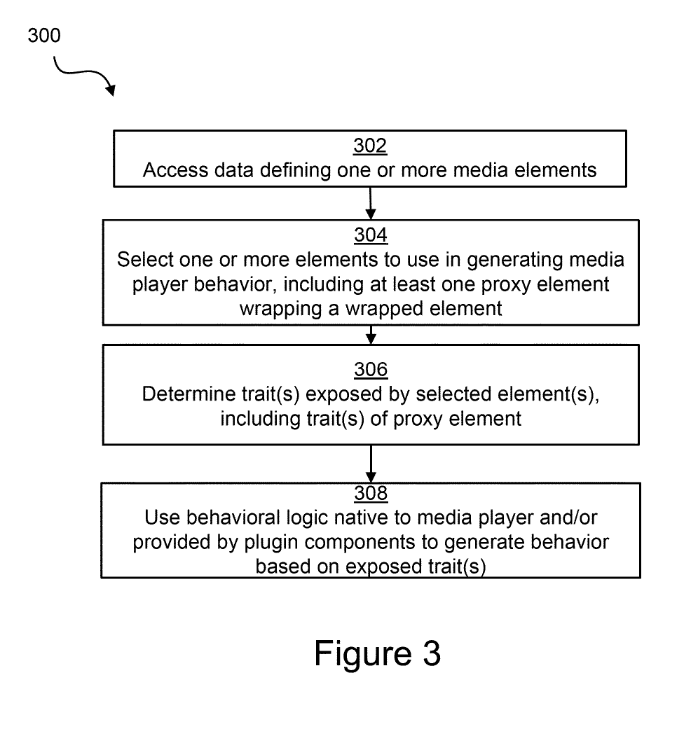

FIG. 3 is a flowchart showing steps in an exemplary method 300 of trait-based media player behavior. Block 302 represents accessing data defining one or more media elements of a media composition. For example, a playlist file may be accessed or data defining the elements as declarations in code for a media player can be accessed while the media player is executing.

Block 304 represents selecting one or more elements to use in generating media player behavior. For example, the elements may be declared or defined as a series of nested elements in series and/or in parallel. Based on the arrangement of elements, one or more elements can be considered as the current source for media player output at a given point in time. For example, a video, audio, and still image element may be presented in parallel.

Block 306 represents determining one or more traits exposed by the selected elements and block 308 represent using behavioral logic of the media player to generate behavior based on the exposed traits. For non-proxy media elements, for instance, the traits can be used to determine which API calls are available for use in providing output. For example, an image element may expose a “visible” trait, which can cause the media player to support a “display( )” command along with screen coordinates. Logic in the media player (e.g., raster or vector imaging routines) can be used to render the element on screen.

If proxy elements are supported, block 306 may also represent identifying a wrapped media element, the wrapped media element wrapped by a proxy media element and determining a trait exposed by the proxy media element, with the trait(s) as exposed by the proxy media element used to generate media player behavior at block 308. For example, the proxy media element may be cross-referenced to plugin code that is used to generate behavior in addition to or instead of behavior generated by logic native to the media player. As another example, the proxy media element may be defined with one or more parameters indicating a trait to be added. For instance, a “TemporalProxy” element may be wrapped around an ordinarily-static media element and expose the “temporal” trait and an associated duration parameter.

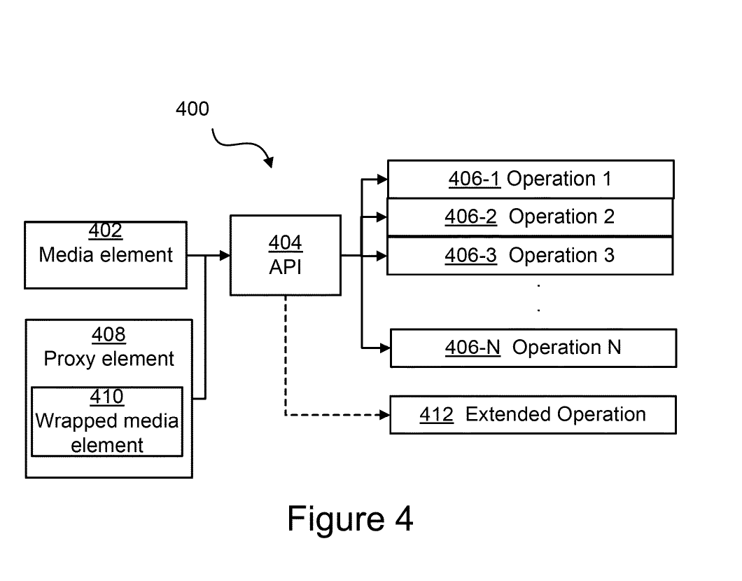

FIG. 4 is a diagram 400 illustrating operation of a media player that supports proxy media elements. In this example, a media element 402 is shown invoking one or more operations 406 via a media player API 404. For example, media element 402 may be “visible” and “temporal,” and thus can invoke an operation used to render video onscreen based on content defined by element 402 and an operation used to present playback controls (e.g., play, pause, rewind) used to invoke playback commands supported by a program component (e.g., a video object) corresponding to media element 402.

A proxy element 408 is shown wrapping another media element (wrapped media element 410). Proxy element 408 may invoke one or more of operations 406 via API 404. For example, proxy element 408 may expose one or more traits that would ordinarily have been exposed by wrapped media element 410. For instance, if wrapped media element 410 comprises an image file, proxy element 408 may expose the “visible” trait and thus can invoke operations 406 related to rendering a display of the image onscreen.

However, as indicated by the dotted line, proxy element 408 may also invoke another operation (extended operation 412) not natively supported by logic of the media player. For example, the image may be intended to display onscreen as a set of controls for a specific social network. The logic for providing the controls (e.g., logic for submitting various HTTP POST requests or other invocations of a web service supported by the social network) can be specified in a plugin. The proxy element can be identified as a “proxy” by components implementing API 404 (e.g., the media identification module of FIG. 2) so that various click events on the overlay are routed to the plugin logic to result in appropriate requests to the social network.

As another example, proxy element 408 can be associated with a layout plugin that overrides the position, size, and other attributes otherwise associated with the “viewable” trait. Thus, rather than enabling the native behavioral logic of the media player (as represented by one or more of operations 406) in response to the “viewable” trait, the layout logic of the layout plugin can control the position and sizing properties of wrapped element 410. The media player may still utilize other native operations 406 (e.g., video or image playback components).

Additionally, proxy elements may be configured to proxy existing elements. For example, a plugin may declare that its proxy should wrap any elements that meet a particular parameter. For instance, a tracking proxy may be registered with the media player as wrapping any video element handling a URL with the “.flv” file type. Thus, any video element with that “.flv” parameter would be treated as a wrapped element exposing the traits of an ordinary video element as adjusted by the tracking proxy. For instance, the tracking proxy may intercept and mirror events or commands provided to the wrapped element or perform other desired operations. By associating the plugin with particular parameters, the plugin developer can control or constrain what media experiences the plugin adjusts.

The examples noted above are not intended to be limiting. For example, as the API for a media player is extended to support additional operations, plugin and other proxy-related operations may be extended to adjust traits associated with the additional operations.

### General Considerations

Some portions of the detailed description were presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here and generally is considered to be a self-consistent sequence of operations or similar processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels.

Unless specifically stated otherwise, as apparent from the foregoing discussion, it is appreciated that throughout this specification discussions utilizing terms such as “processing,” “computing,” “calculating,” “determining” or the like refer to actions or processes of a computing platform, such as one or more computers and/or a similar electronic computing device or devices, that manipulate or transform data represented as physical electronic or magnetic quantities within memories, registers, or other information storage devices, transmission devices, or display devices of the computing platform.

The various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software, that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, personal digital assistants (PDAs), cellular telephones, televisions, television set-top boxes, portable music players, and consumer electronic devices such as cameras, camcorders, and mobile devices. Computing devices may be integrated into other devices, e.g. “smart” appliances, automobiles, kiosks, and the like.

The inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel.

When data is obtained or accessed as between a first and second computer system or components thereof, the actual data may travel between the systems directly or indirectly. For example, if a first computer accesses data from a second computer, the access may involve one or more intermediary computers, proxies, and the like. The actual data may move between the first and second computers, or the first computer may provide a pointer or metafile that the second computer uses to access the actual data from a computer other than the first computer, for instance. Data may be “pulled” via a request, or “pushed” without a request in various embodiments.

The technology referenced herein also makes reference to communicating data between components or systems. It should be appreciated that such communications may occur over any suitable number or type of networks or links, including, but not limited to, a dial-in network, a local area network (LAN), wide area network (WAN), public switched telephone network (PSTN), the Internet, an intranet or any combination of hard-wired and/or wireless communication links.

Any suitable tangible computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A method, comprising:
identifying, by a computing system providing a media player, a wrapped media element, the wrapped media element wrapped by a proxy media element, wherein the wrapped media element is declared in executable code defining a media presentation, the executable code being instructions used by the media player to utilize a selectively-enabled functional component of the media player, wherein the selectively-enabled functional component is not natively supported by logic of the media player;
determining a trait exposed by the proxy media element; and
generating the selectively-enabled functional component to provide a media player behavior based on the exposed trait.

2. The method set forth in claim 1, wherein determining a trait comprises determining a trait exposed by the wrapped media element and treating the trait exposed by the wrapped media element as being exposed by the proxy media element.

3. The method set forth in claim 1, wherein determining a trait comprises determining a trait exposed by the wrapped media element and identifying a change to the trait based on a parameter included in code defining the proxy media element, the trait as changed comprising the trait of the proxy media element.

4. The method set forth in claim 1, wherein determining a trait comprises identifying a trait based on a parameter included in code defining the proxy media element, the identified trait being different from a trait, if any, exposed by the wrapped media element.

5. The method set forth in claim 1, wherein generating the selectively-enabled functional component to provide a media player behavior comprises invoking an operation supported by code of the media player.

6. The method set forth in claim 1, wherein generating the selectively-enabled functional component to provide a media player behavior comprises invoking an operation supported by code of a plugin, the plugin associated with the proxy media element.

7. A computing system comprising a processor with access to a tangible computer-readable medium embodying program components, the program components comprising:
a media element identification module that configures the computing system to access code defining a media presentation, identify a media element comprised in the media presentation, and determine a trait exposed by the media element; and
a behavioral module that configures the computing system to generate a selectively-enabled functional component to provide media player behaviors based on the trait exposed by the media element,
wherein the media element identification module configures the computing system to determine if the media element comprises a proxy media element wrapping a wrapped media element, wherein the wrapped media element is declared in executable code defining the media presentation, wherein the executable code is instructions used by a media player to utilize the selectively-enabled functional component of the media player, and, if so, to determine the trait exposed by the media element based on a parameter included in code defining the proxy media element, wherein the selectively-enabled functional component is not natively supported by logic of the media player.

8. The system set forth in claim 7, wherein determining a trait comprises determining a trait exposed by the wrapped media element and treating the trait exposed by the wrapped media element as being exposed by the proxy media element.

9. The system set forth in claim 7, wherein determining a trait comprises determining a trait exposed by the wrapped media element and identifying a change to the trait based on the parameter included in code defining the proxy media element, the trait as changed comprising the trait of the proxy media element.

10. The system set forth in claim 7, wherein determining a trait comprises identifying a trait based on a parameter included in code defining the proxy media element, the identified trait being different from a trait, if any, exposed by the wrapped media element.

11. The system set forth in claim 7, wherein generating the selectively-enabled functional component to provide a media player behavior comprises invoking an operation supported by code of the media player.

12. The system set forth in claim 7, wherein generating the selectively-enabled functional component to provide a media player behavior comprises invoking an operation supported by code of a plugin, the plugin associated with the proxy media element.

13. A computer program product comprising code executable by a computing system and embodied in a non-transitory tangible computer readable medium, the code comprising:
program code that causes a computing system to identify a wrapped media element, the wrapped media element wrapped by a proxy media element, wherein the wrapped media element is declared in executable code defining a media presentation, the executable code being instructions used by a media player to utilize a selectively-enabled functional component of the media player, wherein the selectively-enabled functional component is not natively supported by logic of the media player;
program code that causes a computing system to determine a trait exposed by the proxy media element; and
program code that causes a computing system to generate the selectively-enabled functional component to provide a media player behavior based on the exposed trait.

14. The computer program product set forth in claim 13, wherein determining a trait comprises determining a trait exposed by the wrapped media element and treating the trait exposed by the wrapped media element as being exposed by the proxy media element.

15. The computer program product set forth in claim 13, wherein determining a trait comprises determining a trait exposed by the wrapped media element and identifying a change to the trait based on a parameter included in code defining the proxy media element, the trait as changed comprising the trait of the proxy media element.

16. The computer program product set forth in claim 13, wherein determining a trait comprises identifying a trait based on a parameter included in code defining the proxy media element, the identified trait being different from a trait, if any, exposed by the wrapped media element.

17. The computer program product set forth in claim 13, wherein generating the selectively-enabled functional component to provide a media player behavior comprises invoking an operation supported by code of the media player.

18. The computer program product set forth in claim 13, wherein generating the selectively-enabled functional component to provide a media player behavior comprises invoking an operation supported by code of a plugin, the plugin associated with the proxy media element.

19. The method of claim 1 wherein the exposed trait is a visible trait or a temporal trait and wherein generating the selectively-enabled functional component to provide a media player behavior based on the exposed trait comprises selectively enabling or disabling aspects of a video playback component based on the presence of the exposed trait.

20. The method of claim 1 wherein the exposed trait is a visible trait or a temporal trait and wherein generating the selectively-enabled functional component to provide a media player behavior based on the exposed trait comprises enabling suitable components for rendering non-video content based on the presence of the exposed trait.

21. The method of claim 1 wherein the exposed trait is a visible trait or a temporal trait and wherein generating the selectively-enabled functional component to provide a media player behavior based on the exposed trait comprises enabling suitable components for rendering audio based on the presence of the exposed trait.

22. The method of claim 1, wherein the executable code is compiled into the media player to utilize the selectively-enabled functional component of the media player.

23. The method of claim 22 wherein the executable code being compiled into the media player comprises compiling into the media player a cross reference to code of a plugin.

24. The method of claim 22 wherein the executable code compiled into the media player comprises compiling into the media player code that intercepts media player commands and replaces the media player commands with code directed to a trait of the proxy media element.
